(19) United States
(12) Patent Application Publication
(10) Pub. No.: US 2026/0107175 A1
(43) Pub. Date: Apr. 16, 2026

(54) TERMINAL, RADIO COMMUNICATION METHOD, AND BASE STATION

(71) Applicant: NTT DOCOMO, INC., Tokyo (JP)

(72) Inventors: Yuki Matsumura, Chiyoda-ku, Tokyo (JP); Satoshi Nagata, Chiyoda-ku, Tokyo (JP); Jing Wang, Haidian District, Beijing (CN); Lan Chen, Haidian District, Beijing (JP)

(73) Assignee: NTT DOCOMO, INC., Tokyo (JP)

(21) Appl. No.: 19/116,152

(22) PCT Filed: Oct. 7, 2022
(86) PCT No.: PCT/JP2022/037600

§ 371 Date: Mar. 27, 2025

(51) Int. Cl. H04W 24/10; H04W 36/08

(52) U.S. Cl. CPC H04W 24/10; H04W 36/08

(57) ABSTRACT

A terminal according to an aspect of the present disclosure includes: a control section that transmits, when a Layer 1 (L1) measurement result meets a condition, a specific indication from a physical layer to a Medium Access Control (MAC) layer, counts the specific indication in the MAC layer, and triggers, based on a counter value, an aperiodic CSI report; and a transmitting section that transmits the aperiodic CSI report. An aspect of the present disclosure enables CSI reporting to be appropriately performed.

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency, and the like (Non-Patent Literature 1). In addition, for the purpose of further high capacity, advancement, and the like of LTE (Third Generation Partnership Project (3GPP (registered trademark)) Release (Rel.) 8 and Rel. 9), the specifications of LTE-Advanced (3GPP Rel. 10 to Rel. 14) have been drafted.

Successor systems of LTE (for example, also referred to as “5th generation mobile communication system (5G),” “5G+ (plus),” “6th generation mobile communication system (6G),” “New Radio (NR),” “3GPP Rel. 15 (or later versions),” and the like) are also under study.

### CITATION LIST

### Non-Patent Literature

Non-Patent Literature 1:3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

For radio communication systems, it is studied that one or a plurality of cells/transmission/reception points (TRPs) (multi-TRP (MTRP)) perform downlink (DL) transmission to a terminal (user terminal, User Equipment (UE)).

In a case of applying multi-TRP, with signaling of at least one of layer 1 and layer 2, a serving cell may be switched to a cell (additional cell) with a PCI different from that of the serving cell (L1/L2 inter-cell mobility (layer1/layer2 inter-cell mobility)).

Meanwhile, in a case of applying at least one of inter-cell mobility with cells including a non-serving cell and a multi-TRP scenario, it is not clear how L1 beam reporting (channel state information (CSI) reporting) in each cell is performed. Unless CSI reporting is performed appropriately, an issue such as reduction in communication throughput may be caused.

In view of this, an object of the present disclosure is to provide a terminal, a radio communication method, and a base station that enable CSI reporting to be appropriately performed.

### Solution to Problem

A terminal according to an aspect of the present disclosure includes: a control section that transmits, when a Layer 1 (L1) measurement result meets a condition, a specific indication from a physical layer to a Medium Access Control (MAC) layer, counts the specific indication in the MAC layer, and triggers, based on a counter value, an aperiodic CSI report; and a transmitting section that transmits the aperiodic CSI report.

### Advantageous Effects of Invention

An aspect of the present disclosure enables CSI reporting to be appropriately performed.

### BRIEF DESCRIPTION OF DRAWINGS

FIG. 1 FIGS. 1A to 1D are each a diagram to show a configuration example of multi-TRP.

FIG. 2 FIG. 2A is a diagram to show an example of mobility of a UE in Rel. 17. FIG. 2B is a diagram to show an example of mobility of a UE in Rel. 18.

FIG. 3 is a diagram to show an example of association between serving cells and candidate cells.

FIG. 4 FIG. 4A is a diagram to show a first example of ServingCellConfig in Option 1. FIG. 4B is a diagram to show a second example of ServingCellConfig in Option 1.

FIG. 5 is a diagram to show a first example of Option 2.

FIG. 6 FIG. 6A is a diagram to show a second example of Option 2. FIG. 6B is a diagram to show a third example of Option 2.

FIG. 7 is a diagram to show Serving Cell Switch Example 1.

FIG. 8 is a diagram to show Serving Cell Switch Example 2.

FIG. 9 is a diagram to show Serving Cell Switch Example 3.

FIG. 10 is a diagram to show an overview of a CSI report configuration of RRC.

FIG. 11 is a diagram to show part of a CSI resource configuration in Rel. 17.

FIG. 12 is a diagram to show part of a CSI-SSB resource set in Rel. 17.

FIG. 13 is a diagram to show a configuration related to L3 measurement/reporting in Rel. 17.

FIG. 14 is a flowchart to show an example of processing according to a first embodiment.

FIG. 15 is a diagram to show an example of an overview of a fourth embodiment.

FIG. 16 is a diagram to show an example of a schematic structure of a radio communication system according to one embodiment.

FIG. 17 is a diagram to show an example of a structure of a base station according to one embodiment.

FIG. 18 is a diagram to show an example of a structure of a user terminal according to one embodiment.

FIG. 19 is a diagram to show an example of a hardware structure of the base station and the user terminal according to one embodiment.

FIG. 20 is a diagram to show an example of a vehicle according to one embodiment.

### DESCRIPTION OF EMBODIMENTS

### Multi-TRP

For NR, it is under study that one or a plurality of transmission/reception points (TRPs) (multi-TRP) perform DL transmission to a UE by using one or a plurality of panels (multi-panel). It is also studied that the UE performs UL transmission to the one or plurality of TRPs.

Note that the plurality of TRPs may correspond to the same cell identifier (ID) or may correspond to different cell IDs. The cell ID may be a physical cell ID (PCI) or a virtual cell ID.

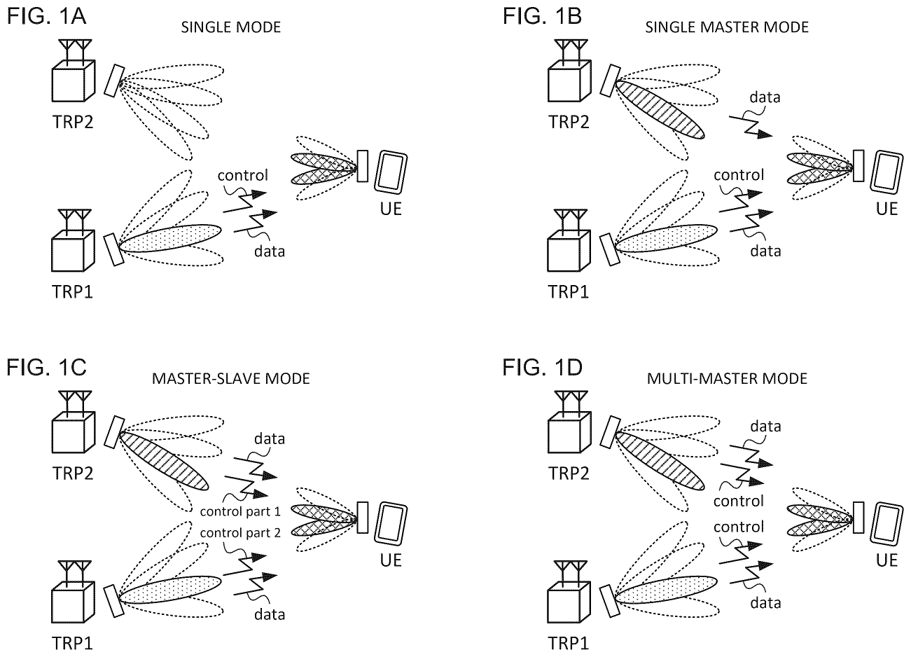

FIGS. 1A to 1D are each a diagram to show an example of a multi-TRP scenario. In these examples, it is assumed that each TRP is possible to transmit four different beams, but examples are not limited to this.

FIG. 1A shows an example of a case where only one TRP (TRP 1 in this example) out of multi-TRP performs transmission to a UE (which may be referred to as a single mode, a single TRP, or the like). In this case, TRP 1 transmits both a control signal (PDCCH) and a data signal (PDSCH) to the UE.

FIG. 1B shows an example of a case where only one TRP (TRP 1 in this example) out of multi-TRP transmits a control signal to a UE and the multi-TRP each transmits a data signal (which may be referred to as a single master mode). The UE receives respective PDSCHs transmitted from the multi-TRP, based on one piece of downlink control information (DCI).

FIG. 1C shows an example of a case where each TRP of multi-TRP transmits part of a control signal to a UE and the multi-TRP each transmits a data signal (which may be referred to as a master-slave mode). TRP 1 may transmit part 1 of the control signal (DCI) and TRP 2 may transmit part 2 of the control signal (DCI). Part 2 of the control signal may depend on part 1. The UE receives respective PDSCHs transmitted from the multi-TRP, based on these parts of the DCI.

FIG. 1D shows an example of a case where respective TRPs of multi-TRP transmit separate control signals to a UE and the multi-TRP each transmits a data signal (which may be referred to as a multimaster mode). TRP 1 may transmit a first control signal (DCI) and TRP 2 may transmit a second control signal (DCI). The UE receives respective PDSCHs transmitted from the multi-TRP, based on these pieces of DCI.

In a case where a plurality of PDSCHs (which may be referred to as multi-PDSCH (multiple PDSCHs)) from the multi-TRP as in FIG. 1B are scheduled by using one piece of DCI, the DCI may be referred to as single DCI (S-DCI, single PDCCH). In a case where a plurality of PDSCHs from the multi-TRP as in FIG. 1D are scheduled by using respective pieces of DCI, these plurality of pieces of DCI may be referred to as multi-DCI (M-DCI, multi-PDCCH (multiple PDCCHS)).

From respective TRPs of the multi-TRP, different transport blocks (TBs)/codewords (Code Words (CWs))/different layers may be transmitted. Alternatively, from respective TRPs of the multi-TRP, the same TB/CW/layer may be transmitted.

As one mode of multi-TRP transmission, non-coherent joint transmission (NCJT) is under study. In NCJT, for example, TRP 1 performs modulation mapping on a first codeword, performs layer mapping, and transmits a first PDSCH in layers of a first number (for example, two layers) by using first precoding. TRP 2 performs modulation mapping on a second codeword, performs layer mapping, and transmits a second PDSCH in layers of a second number (for example, two layers) by using second precoding.

Note that a plurality of PDSCHs (multi-PDSCH) transmitted by NCJT may be defined to partially or entirely overlap in terms of at least one of the time and frequency domains. In other words, a first PDSCH from a first TRP and a second PDSCH from a second TRP may have an overlap in terms of at least one of the time and frequency resources.

The first PDSCH and the second PDSCH may be assumed not to be in a quasi-co-location (QCL) relationship (not to be quasi-co-located). Reception of the multi-PDSCH may be interpreted as simultaneous reception of PDSCHs of a QCL type other than a certain QCL type (for example, QCL type D).

For URLLC for multi-TRP, it is under study to support PDSCH (transport block (TB) or codeword (CW)) repetition over multi-TRP. It is under study to support a scheme of repetition over multi-TRP in the frequency domain, layer (space) domain, or time domain (URLLC scheme, for example, schemes 1, 2a, 2b, 3, and 4). In scheme 1, multi-PDSCH from multi-TRP is space division multiplexed (SDMed). In schemes 2a and 2b, PDSCHs from multi-TRP are frequency division multiplexed (FDMed). In scheme 2a, the same redundancy version (RV) is used for the multi-TRP. In scheme 2b, the same or different RVs may be used for the multi-TRP. In schemes 3 and 4, multi-PDSCH from multi-TRP is time division multiplexed (TDMed). In scheme 3, multi-PDSCH from multi-TRP is transmitted in one slot. In scheme 4, multi-PDSCH from multi-TRP is transmitted in different slots.

Such a multi-TRP scenario enables more flexible transmission control using a channel with high quality.

In NCJT using multi-TRP/multi-panel, a high rank may be used. In order to support ideal and non-ideal backhaul between a plurality of TRPs, both single DCI (single PDCCH, for example, FIG. 1B) and multi-DCI (multi-PDCCH, for example, FIG. 1D) may be supported. For both of the single DCI and the multi-DCI, the maximum number of TRPs may be two.

For single PDCCH design (for ideal backhaul, mainly), TCI enhancement is under study. Every TCI codepoint in DCI may correspond to one or two TCI states. A TCI field size may be the Same as that of Rel. 15.

### L1/L2 Inter-Cell Mobility

As described above, it is under study that a UE performs UL transmission to one or a plurality of cells/TRPs. As a procedure in such a case, Scenario 1 or Scenario 2 below is conceivable.

Note that, in the present disclosure, a serving cell may be interpreted as a TRP in the serving cell. Layer1/layer2 (L1/L2) and DCI/Medium Access Control Control Element (MAC CE) may be interchangeably interpreted. In the present disclosure, a physical cell ID (Physical Cell Identity (PCI)) different from a PCI of a current serving cell may be simply referred to as a “different PCI.” A non-serving cell, a cell having a different PCI, and an additional cell may be interchangeably interpreted.

### Scenario 1

Although Scenario 1 corresponds, for example, to multi-TRP inter-cell mobility, a scenario not corresponding to multi-TRP inter-cell mobility may be possible.
(1) A UE receives, from a serving cell, a configuration of an SSB for beam measurement of a TRP corresponding to a PCI different from that of the serving cell and a configuration required to use a radio resource for data transmission and reception, including a resource for the different PCI.
(2) The UE performs beam measurement of the TRP corresponding to the different PCI to report a beam measurement result to the serving cell.
(3) Based on the reporting described above, a transmission configuration indication (ICI) state associated with the TRP Corresponding to the different PCI is activated by L1/L2 signaling from the serving cell.
(4) The UE performs transmission and reception by using a UE-dedicated channel on the TRP corresponding to the different PCI.
(5) The UE is required to cover the serving cell all the time, including a case of multi-TRP. The UE is, similarly to an existing system, required to use a common channel (broadcast control channel (BCCH), paging channel (PCH)) or the like from the serving cell.

In Scenario 1, when the UE transmits and receives a signal to and from an additional cell/TRP (a TRP corresponding to a PCI of the additional cell), the serving cell (serving cell assumption by the UE) is not changed. The UE is, from the serving cell, configured with a higher layer parameter related to a PCI of a non-serving cell. Scenario 1 may be applied in Rel. 17, for example.

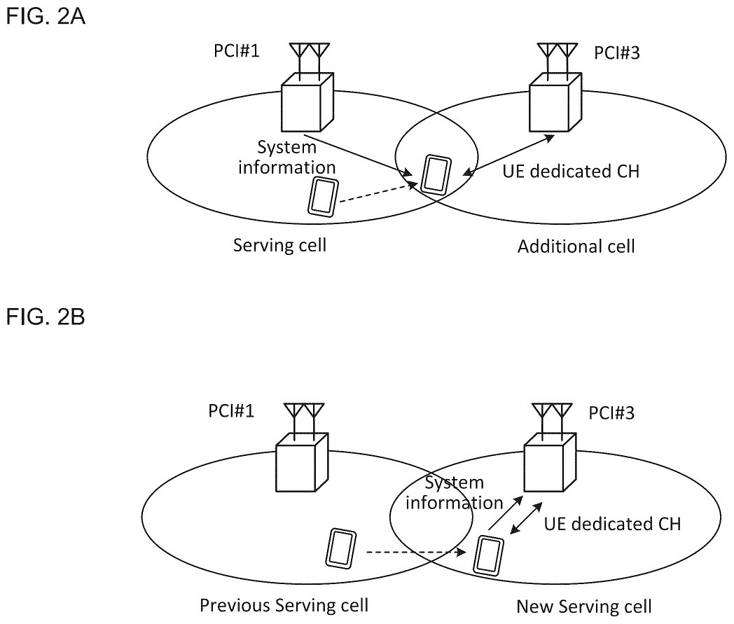

FIG. 2A is a diagram to show an example of mobility of a UE in Rel. 17. It is assumed that the UE moves from a cell (serving cell) of PCI #1 to a cell (additional cell) of PCI #3 (having an overlap with the serving cell). In this case, in Rel. 17, the serving cell is not switched by L1/L2. The additional cell is a cell having an additional PCI different from the PCI of the serving cell. The UE can receive/transmit a UE-dedicated channel from the additional cell. The UE is required to be in a coverage of the serving cell in order to receive a UE-common channel (for example, system information/paging/short message).

### Scenario 2

In Scenario 2, L1/L2 inter-cell mobility is used. In L1/L2 inter-cell mobility, serving cell change can be performed by using a function such as beam control, without performing RRC reconfiguration. In other words, transmission and reception to and from an additional cell can be performed, without handover. Handover requires RRC reconnection or the like that causes a data communication disabled period, and thus L1/L2 inter-cell mobility not requiring such handover is used, thereby enabling data communication to be continued even in serving cell change. In Scenario 2, for example, the following procedure is performed.
(1) A UE receives, from a serving cell, a configuration of an SSB of a cell (additional cell) having a different PCI in order for beam measurement/serving cell change.
(2) The UE performs beam measurement for the cell using the different PCI to report a measurement result to the serving cell.
(3) The UE may receive a configuration (serving cell configuration) of the cell having the different PCI by higher layer signaling (for example, RRC) . In other words, pre-configuration related to the serving cell change is performed.

Such configuration may be performed together with configuration in (1) or may be performed separately.
(4) Based on the reporting described above, a TCI state for the cell having the different PCI is activated by L1/L2 signaling in accordance with the serving cell change. The activation of the TCI state and the serving cell change may be performed separately.
(5) The UE changes the serving cell (serving cell assumption) and, by using a pre-configured UE-dedicated channel and the TCI state, initiates reception/transmission.

In other words, in Scenario 2, the serving cell (serving cell assumption by the UE) is updated by L1/L2 signaling. Scenario 2 may be applied in Rel. 18.

FIG. 2B is a diagram to show an example of mobility of a UE in Rel. 18. In Rel. 18, the serving cell is switched by L1/L2. The UE can receive/transmit, from and to a new serving cell, a UE-dedicated channel/common channel. The UE may be out of the coverage of a previous serving cell.

### Configuration of Plurality of Candidate Cells

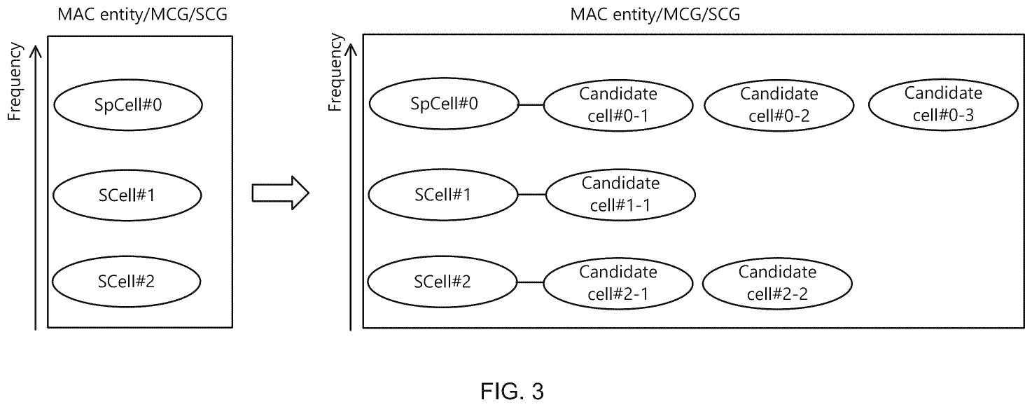

FIG. 3 is a diagram to show an example of association between serving cells and candidate cells. SpCell #0, SCell #1, or SCell #2 is assumed to be a serving cell. Note that an SpCell means a special cell (including a primary cell (PCell) and a primary secondary cell (PSCell)). An SCell means a secondary cell. SpCell #0 is associated with Candidate cell #0-1, Candidate cell #0-2, and Candidate cell #0-3. SCell #1 is associated with Candidate cell #1-1. SCell #2 is associated with Candidate cell #2-1 and Candidate cell #2-2. As described above, one or more candidate cells (candidate serving cells) may be associated with a serving cell.

Regarding a configuration of a cell to be a candidate (candidate cell) in a case of changing a serving cell, for example, Option 1 and Option 2 below are conceivable.

### Option 1

Information in ServingCellConfig may include information related to a plurality of candidate cells, as in inter-cell mobility in Rel. 17. In this case, the plurality of candidate cells are required to share the same configuration of PDCCH/PDSCH/UL or the like with the serving cell.

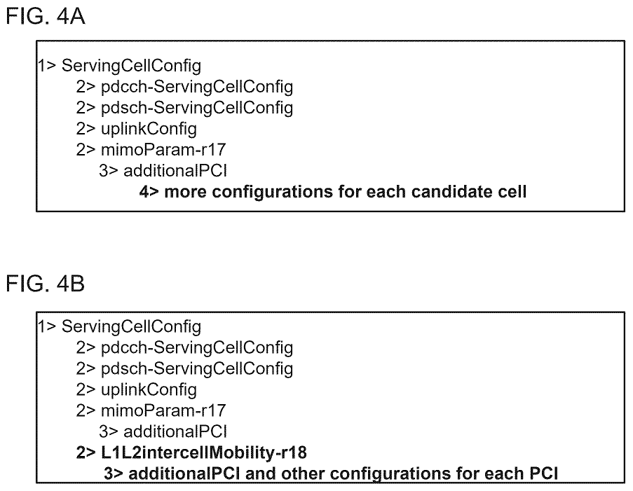

For example, for inter-cell mobility in Rel. 17, it is under study that “mimoParam-r17” is added under ServingCellConfig and PCI configuration information is added (FIGS. 4A and 4B). This framework is applied to a case where cells having different PCIs share the same configuration of PDCCH/PDSCH/UL or the like.

More configurations, such as an LTE CRS pattern and an RACH configuration, may be applied to each candidate cell. With a cell-specific CSI-RS configuration (for CSI/TRS) taken into account, a different CSI-RS occasion/resource is possible to be configured per cell, allowing interference to be reduced.

FIG. 4A is a diagram to show a first example of ServingCellConfig in Option 1. In FIG. 4A, ServingCellConfig includes configurations for an additional cell (each candidate cell). FIG. 4B is a diagram to show a second example of ServingCellConfig in Option 1. In FIG. 4B, ServingCellConfig includes configurations for an additional cell (each candidate cell) for L1/L2 inter-cell mobility. FIG. 4A corresponds to Scenario 1 described above, for example. FIG. 4B corresponds to Scenario 2 described above, for example.

As in FIGS. 4A and 4B, a candidate cell is pre-configured by RRC. As an initial state, a candidate cell may be fixed to be in a state activated/deactivated in a specification or may be configured, by RRC, to be in a state activated/deactivated.

Furthermore, a candidate cell in L1/L2 cell switch may be activated/deactivated by a MAC CE. L1/L2 cell switch indication may be transmitted only for a cell from among active cells.

### Option 2

A plurality of candidate cells may be applied with a complete configuration (for example, ServingCellConfig) corresponding to the cells and may be, by re-using a carrier aggregation (CA) configuration framework, associated with serving cells. A UE is provided with the complete configuration for the candidate cells, allowing the UE to perform appropriate communication with the candidate cells.

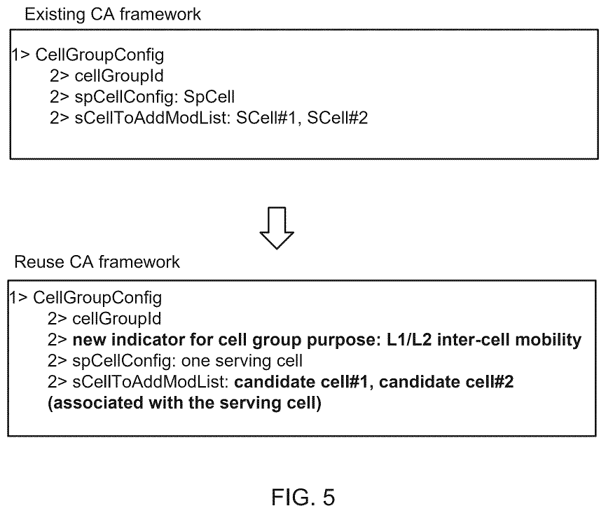

In the CA configuration framework, it is possible to configure an SpCell per cell group and to add a plurality of SCells. With a CA framework re-used, a serving cell may be configured per cell group in L1/L2 inter-cell mobility and a plurality of candidate cells may be configured (FIG. 5). A. candidate cell may be activated/deactivated by a MAC CE. Such a method is considered profitable for complexity in UE operations to be reduced. As an example, CellGroupConfig with cell group ID 0 is shown.

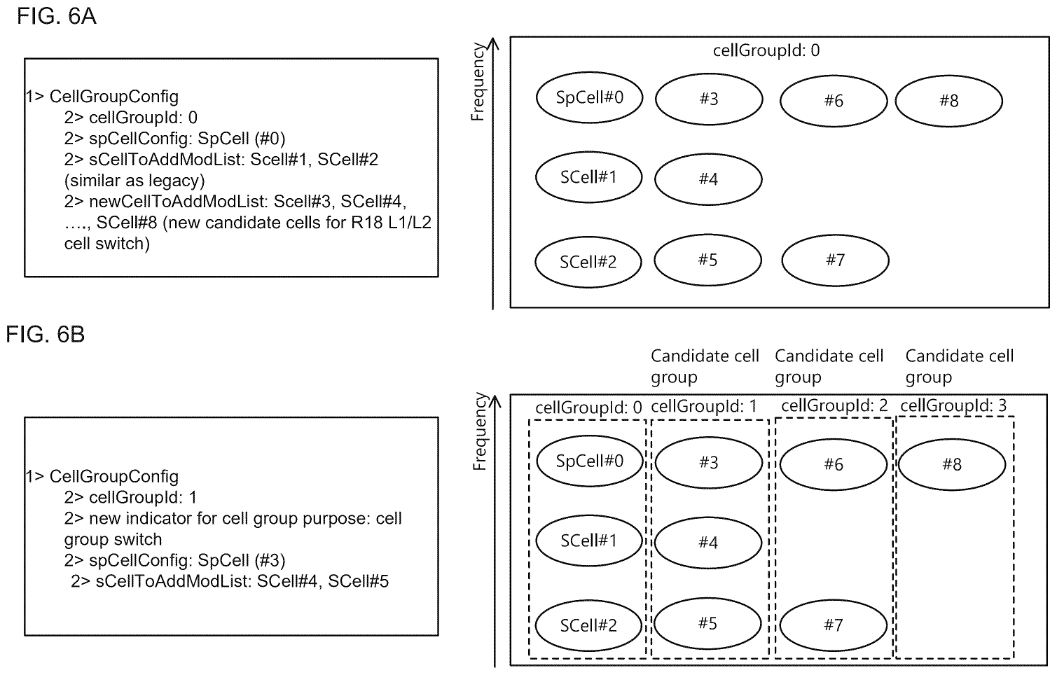

FIG. 6A is a diagram to show a second example of Option 2. In the example of FIG. 6A, for candidate cells, a common candidate cell pool for cell switch in an MCG/SCG is applied. In other words, the candidate cells are handled as one pool (group), regardless of a frequency band.

FIG. 6B is a diagram to show a third example of Option 2. In the example of FIG. 6B, a plurality of cell groups are configured and cell group switch is possible to be made by L1/L2 signaling. A candidate cell is configured per cell group and a configuration for each group includes indices of corresponding SpCell and SCell. In CellGroupConfig in FIG. 6B, CellGroupConfig with cell group ID 1 is shown as an example. Separately from this, CellGroupConfig with cell group ID 2 and CellGroupConfig with cell group ID 3 are configured.

### Signaling for Serving Cell Change Indication

Implicit or explicit signaling for serving cell change indication will be described.

### Aspect 1

In Aspect 1, implicit signaling for serving cell change indication is described.

### Option 1-1

In a case where a specific control resource set (CORESET) (for example, at least one of CORESET #0, CH5 Type0-CSS CORESET, and CH6/CH7/CH8 CSS CORESET) is indicated (activated) by a MAC CE together with one or more TCI states associated with a cell having a PCI different from a PCI of a serving cell (a case where the one or more TCI states associated with the cell having the PCI different from the PCI of the serving cell are indicated/activated, by the MAC CE, for the specific CORESET), a UE may judge the serving cell is to be changed to another cell (cell x, a cell having a different PCI). In other words, this activation may implicitly indicate change of the serving cell to another cell.

In this case, the UE may update another CORESET ID, another CORESET using CH6/CH7/CH8, or a beam of another CORESET using CSS to a TCI state the same as the one or more TCI states activated as above.

### Option 1-2

In a case where a MAC CE activates/deactivates TCI states for a PDSCH, when all of the ICI states activated by the MAC CE are associated with the same cell x having a PCI different from a PCI of a serving cell, a UE may judge the serving cell is to be changed to another cell (cell x). In other words, this association may implicitly indicate change of the serving cell to another cell.

In a case of applying this option, when an NW (base station) makes no serving cell change, a MAC CE, in activating TCI states for a PDSCH associated with a cell having a different PCI, is required to include a TCI state related to another cell (for example, a current serving cell or a cell having a second different PCI).

### Option 1-3

In a case where a MAC CE activates/deactivates unified TCI states (for example, corresponding to a unified TCI framework in Rel. 17) and all of the unified TCI states activated are associated with the same cell x having a different PCI, a UE may judge the serving cell is to be changed to another cell (cell x). In other words, this association may implicitly indicate change of the serving cell to another cell.

### Aspect 2

In Aspect 2, explicit signaling for serving cell change indication is described. In Aspect 2, Scenario 2 described above is applied, for example.

### Option 2-1

An example of serving cell change indication is described below. Note that activation/deactivation of a non-serving cell, serving cell change, and transmission/reception to/from another cell (non-serving cell) having a physical cell ID different from a physical cell ID of a serving cell may be interchangeably interpreted.

A UE may receive a new MAC CE that is to be used for activation/deactivation of a non-serving cell and that includes at least one of fields (pieces of information) indicating (1) to (3) below corresponding to the non-serving cell. The UE, when receiving the MAC CE, may judge that the serving cell is to be changed to another cell (non-serving cell). The UE may control, based on the information, transmission and reception of a DL signal/UL signal to and from the non-serving cell. Note that the non-serving cell may be one or may be two or more. In an example shown below, a MAC CE including a plurality of fields indicating a plurality of non-serving cell indices is applied.
(1) Serving Cell Id.
(2) BWP ID.
(3) Non-serving cell ID used for activation. The non-serving cell ID may be replaced with any information (possible to identify a non-serving cell) corresponding to the non-serving cell.

As an example of (3), any one of (3-1) to (3-5) may be applied, for example.
(3-1) PCI (PCI to be used directly). For example, 10 bits are used.
(3-2) Non-serving cell re-creation index (new ID). The new ID may be configured only for a serving cell or non-serving cell that is associated with part of a PCI and that is used by (available for) a UE. The new ID allows the number of bits to be reduced as compared with that for a PCI,
(3-3) CSI report configuration ID (CSI-ReportConfigId) (in a case where CSI-ReportConfig corresponds to one or a plurality of non-serving cells).
(3-4) CSI resource configuration ID (CSI-ResourceConfigId) (in a case where CSI-ResourceConfigId corresponds to one or a plurality of non-serving cells).
(3-5) Bitmap indicating activation/deactivation of every non-serving cell. The size (the number of bits) of the bitmap may be the same as the number of non-serving cells configured on this CC. For example, out of three non-serving cells, when the second non-serving cell is activated, “010” is configured.

At least one of pieces of information included in a MAC CE may be included in DCI. Alternatively, at least one of serving cells activated by the MAC CE may be indicated by the DCI. The MAC CE/DCI may include a field indicating a TCI state/SSB/CSI-RS from a cell having a different PCI, in order for a UE to recognize a DL beam to monitor in a target cell (a serving cell after change). The UE may create, using the TCI state/SSB/CSI-RS, a beam report (CSI report) and transmit the report.

### Option 2-2

A UE may receive a MAC CE obtained by adding a new field “C” of one bit to an existing MAC CE. The field indicate whether to perform serving cell change. The UE may receive the MAC CE and judge, based on the field, whether to change the serving cell to another cell.

### Option 2-3

With respect to the MAC CE in Option 2-2, a field indicating a serving cell index/PCI/another ID (such as the new ID in Option 2-1 described above) and a field of a TCI state/SSB/CSI-RS for a target cell (serving cell after change) may be further included in the MAC CE.

As described above, indication for serving cell change indication is made by a MAC CE/DCI, allowing a UE to appropriately perform serving cell change.

### Serving Cell Switch Example 1

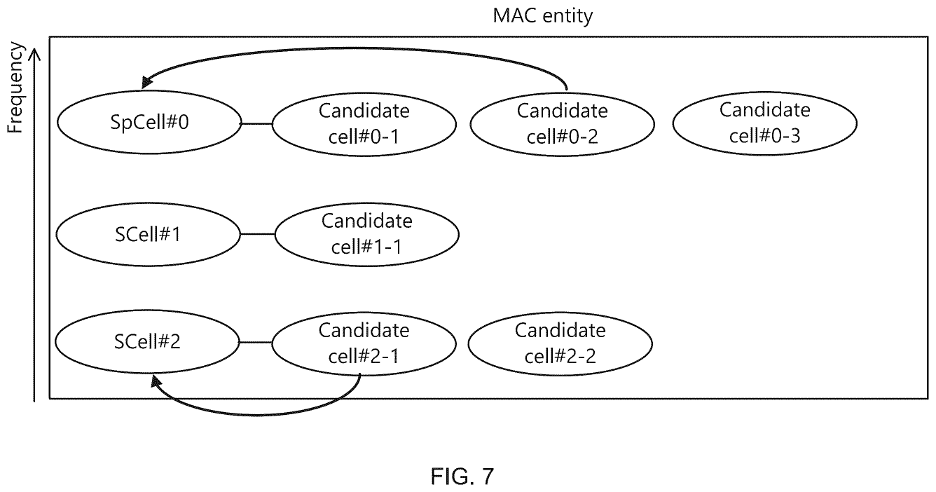

FIG. 7 is a diagram to show Serving Cell Switch Example 1. For example, in a serving cell SpCell #0 in an MCG/SCG, in a case where change of the serving cell to Candidate cell #0-2 is indicated by L1/L2 signaling, Candidate cell #0-2 becomes a new serving cell SpCell #0. For example, in a serving cell SCell #2 in an MCG/SCG, in a case where change of the serving cell to Candidate cell #2-1 is indicated by L1/L2 signaling, Candidate cell #2-1 becomes a new serving cell SCell #2.

### Serving Cell Switch Example 2

RRC/MAC CE can configure a global candidate cell ID (cell #0, . . . , 5) per cell group, band, FR, or UE. Serving cell switch may be indicated, to a UE, with the global candidate cell ID.

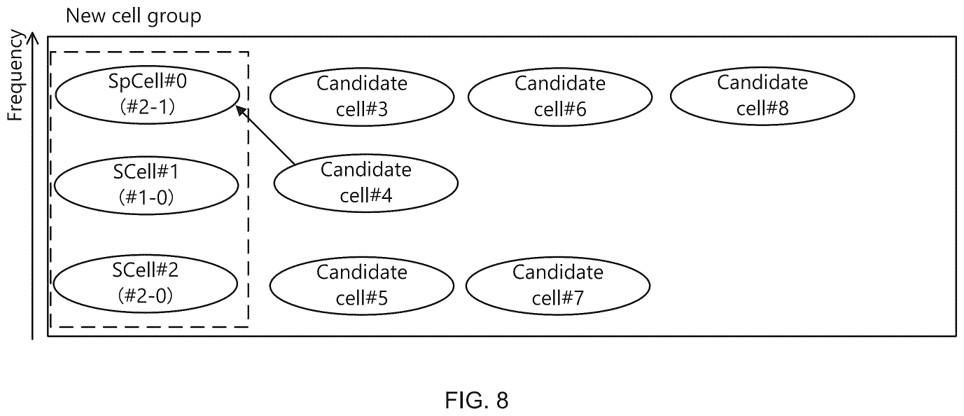

FIG. 8 is a diagram to show Serving Cell Switch Example 2. Similarly to FIG. 6A, a pool of a plurality of candidate cells may be configured and the serving cell may be switched to any (activated) candidate cell in the pool by L1/L2 signaling. In this case, a candidate cell configured can become either an SpCell or Sell on the basis of L1/L2 signaling.

A UE may receive, by a MAC CE/DCI, an indication of serving cell change (from cell #2-1 to candidate cell 4). Then, candidate cell #4 indicated becomes an SpCell in a new cell group.

### Serving Cell Switch Example 3

RRC/MAC CE can configure a global candidate cell ID (cell #0-1, #0-1, . . . , 2-2) per cell group, band, FR, or UE. Serving cell switch may be indicated, to a UE, with the global candidate cell ID.

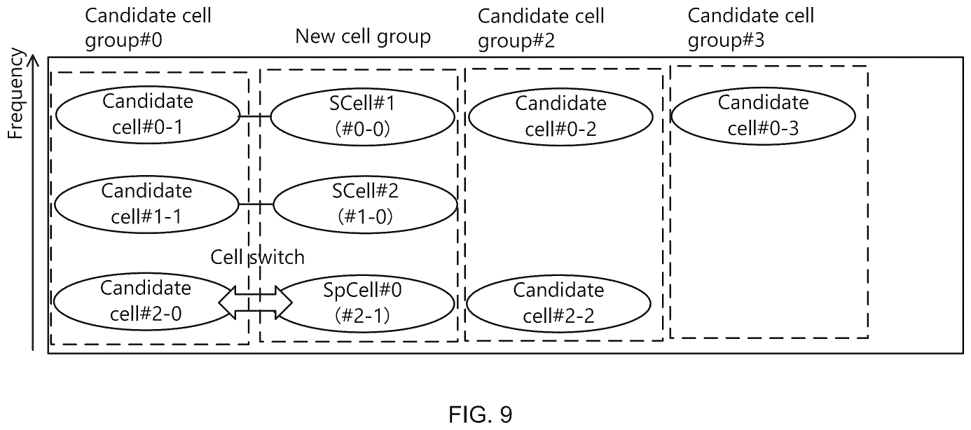

FIG. 9 is a diagram to show Serving Cell Switch Example 3. A UE receives, by a MAC CE/DCI, an indication of serving cell change (from cell #2-0 to cell #2-1). Then, cell #2-1 indicated becomes an SpCell in a new cell group. Cells (cell #0-0 and cell #1-0) in the same cell group as cell #2-1 indicated become Scell #1 and Scell #2. In other words, the serving cell group is switched.

### CSI Report Configuration

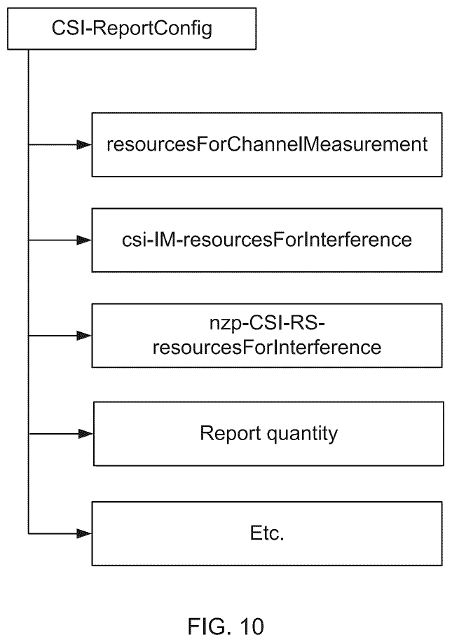

FIG. 10 is a diagram to show an overview of a CSI report configuration of RRC. FIG. 10 shows a CSI report configuration of RRC in 3GPP Rel. 17. As shown in FIG. 10, the CSI report configuration (CSI-ReportConfig) includes configuration information such as resources for channel measurement (“resourcesForChannelMeasurement”), CSI-IM resources for interference measurement (“csi-IM-resourcesForInterference”), non-zero power (NZP) CSI-RS resources for interference measurement (“nzp-CSI-RS-resourcesFor Interference”), and a report quantity (“Report quantity”). Each of “resourcesForChannelMeasurement,” “csi-IM-resourcesForInterference,” and “nzp-CSI-RS-resourcesFor Interference” corresponds to a CSI resource configuration “CSI-ResourceConfig.”

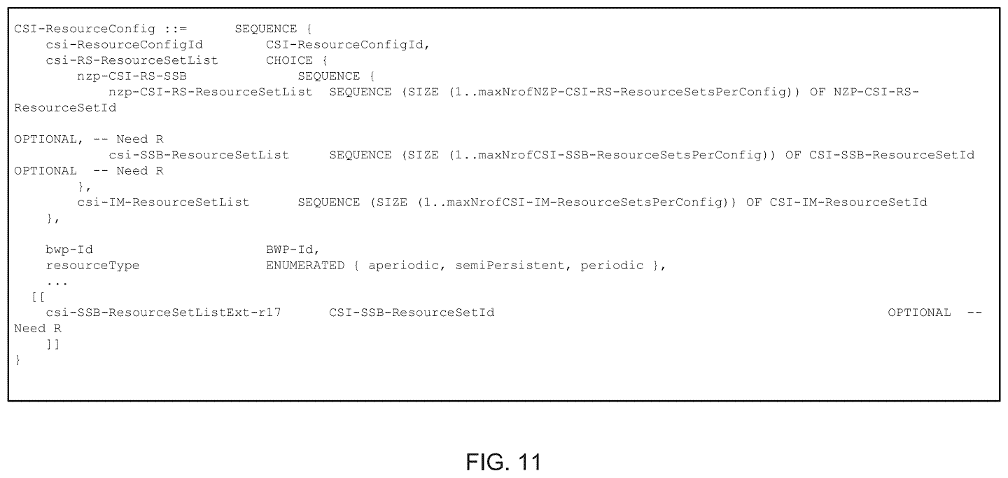

FIG. 11 is a diagram to show part of a CSI resource configuration in Rel. 17. As shown in FIG. 11, a CSI resource configuration (CSI-ResourceConfig) includes “csi-SSB-ResourceSetList.” “csi-SSB-ResourceSetList” is a reference list for SSB resources to be used in CSI measuring and reporting, out of CSI-RS resource sets. “csi-SSB-ResourceSetListExt-r17” is used for addition of an element to “csi-SSB-ResourceSetList” when the number of reported groups (nrofReportedGroups-r17) is configured in the CSI report configuration.

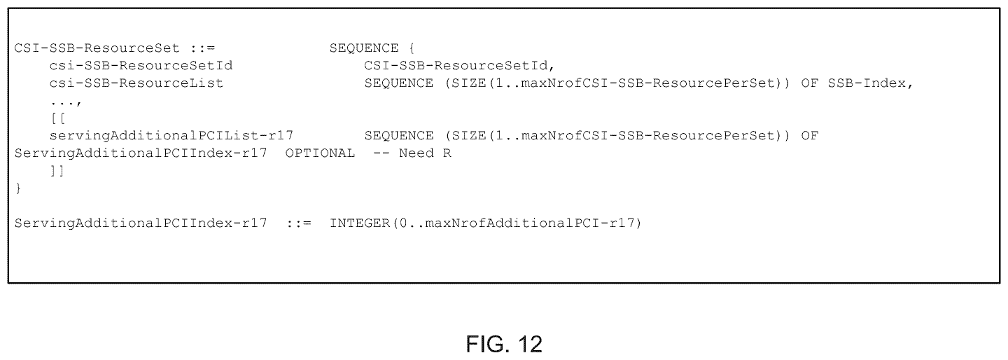

FIG. 12 is a diagram to show part of a CSI-SSB resource set in Rel. 17. As shown in FIG. 12, a CSI-SSB resource set (CSI-SSB-ResourceSet) includes “servingAdditionalPCIList-r17.” “servingAdditionalPCIList-r17” indicates a physical cell ID (PCI) of an SSB included in csi-SSB-ResourceList. When this parameter is present, the list has entries as many as the number of pieces of csi-SSB-ResourceList. The first entry in the list indicates a PCI value for the first entry of csi-SSB-ResourceList, the second entry in the list indicates a PCI value for the second entry of csi-SSB-ResourceList, and this applies similarly to the following entries.

For each entry, when the value is zero, the PCI is a PCI of a serving cell that this CSI-SSB-ResourceSet is defined for. Otherwise (when each entry has a value other than zero), the value of the entry is additionalPCIIndex-r17 of SSB-MTC-AdditionalPCI-r17 in additionalPCIList-r17 of the serving cell configuration (ServingCellConfig), and the PCI is additionalPCI-r17 of this SSB-MTC-AdditionalPCI-r17.

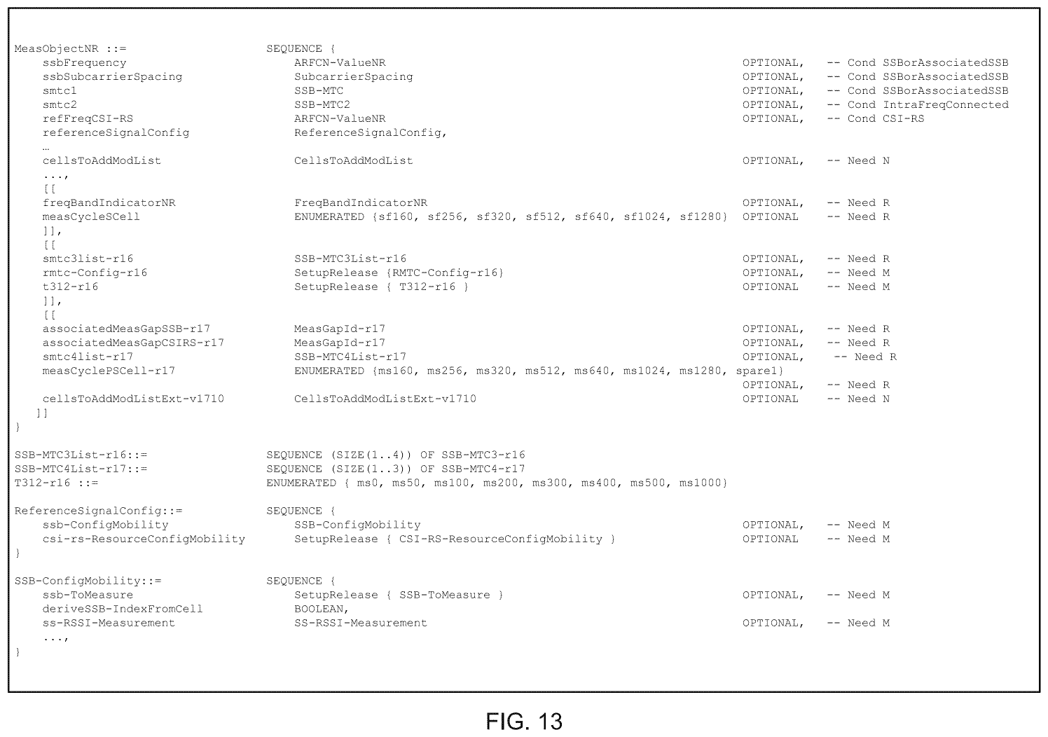

FIG. 13 is a diagram to show a configuration related to L3 measurement/reporting in Rel. 17. associatedMeasGapSSB-r17 indicates an associated measurement gap for SSB measurement identified by ssb-ConfigMobility of a measurement object. When a plurality of pieces of MeasObjectNR having the same SSB frequency are configured, a network configures, for each MeasObjectNR, the same measurement gap ID for this field. When this field is not present, the associated measurement gap is a gap configured via gapFR1, gapFR2, or gapUE.

associatedMeasGapCSIRS-r17 Indicates an Associated measurement qap for CSI-RS measurement identified by csi-rs-ResourceConfigMobility of a measurement object. When this field is not present, the associated measurement gap is a gap configured via gapFR1, gapFR2, or gapUE.

### Reinforcement of L1 Measurement Report for L1/L2 Inter-cell Mobility

When RSS (mainly, SSBs) of a serving cell and non-serving cell are configured in an identical CSI report configuration (or in an identical CSI resource configuration), a UE may report, in addition to an existing report content, some indicators indicating the serving/non-serving cell.

When a new RRC parameter is configured, the UE may report, in addition to an SSB index/CRI and an L1-RSRP/L1-SINR value, an L3-RSRP value (per beam/cell/multi-beam).

### Event-Triggered L1 Beam Reporting for L1/L2 Inter-Cell Mobility

With one or a plurality of existing events for RRM in TS38.331 reused, aperiodic L1 beam reporting may be triggered. In order to trigger aperiodic L1 beam reporting, one or a plurality of new/separate events may be defined. With any combination of two or more events as a trigger, L1 beam reporting may be performed. Each event may be any one of events A2 to A6 and I1 below. In events A2 to A6, a measurement result may be a measurement result of at least one of RSRP (L1-RSRP/L3-RSRP), RSRQ, and SINR (RS-SINR).

Event A2: A measurement result of a serving cell is worse than a threshold.

Event A3: A measurement result (a value obtained by adding an offset to the measurement result) of a neighbour cell is better than a measurement result (a value obtained by adding an offset to the measurement result) of an SpCell.

Event A4: A measurement result (a value obtained by adding an offset to the measurement result) of a neighbour cell is better than a threshold.

Event A5: A measurement result of an SpCell is worse than a first threshold and a measurement result (a value obtained by adding an offset to the measurement result) of a neighbour cell is better than a second threshold.

Event A6: A measurement result (a value obtained by adding an offset to the measurement result) of a neighbour cell is better than a measurement result (a value obtained by adding an offset to the measurement result) of a serving cell (Secondary Cell (SCell)).

Event I1: A measurement result of interference is higher than a threshold.

### Analysis

As described above, in a case of applying multi-TRP, with signaling of at least one of layer 1 and layer 2, a serving cell may be switched to a cell (additional cell) having a PCI different from that of the serving cell (for example, L1/L2 inter-cell mobility (layer1/layer2 inter-cell mobility)).

Meanwhile, in a case where at least one of L1/L2 inter-cell mobility and a multi-TRP scenario is supported, it is not clear how L1 beam reporting (channel state information (CSI) reporting) in each cell is performed. Unless CSI reporting is performed appropriately, an issue such as reduction in communication throughput may be caused. Specifically, examples of the issues are as below.

### Issue 1

In order to trigger an aperiodic CSI report, for the event described above, application of events A2 to A6 and I1 described below is conceivable. For this, however, it is not clear whether triggering of a CSI report using these events is used as it is, whether another element is taken into account, or the like.

### Issue 2

A triggered CSI report includes a measurement result of L1/L3 beam/cell/multi-beam. In a case of performing cell switching, it is not clear how to transmit a cell switching request. Further, triggering of a CSI report in a plurality of cells is not clear.

In view of this, the inventors of the present invention came up with the idea of a terminal, a radio communication method, and a base station that enable CSI reporting to be appropriately performed.

Embodiments according to the present disclosure will be described in detail with reference to the drawings as follows. The radio communication methods according to respective embodiments may each be employed individually, or may be employed in combination.

In the present disclosure, “A/B” and “at least one of A and B” may be interchangeably interpreted. In the present disclosure, “A/B/C” may mean “at least one of A, B, and C.”

In the present disclosure, notify, activate, deactivate, indicate (or specify), select, configure, update, determine, and the like may be interchangeably interpreted. In the present disclosure, “support,” “control,” “controllable,” “operate,” “operable,”and the like may be interchangeably interpreted.

In the present disclosure, radio resource control (RRC), an RRC parameter, an RRC message, a higher layer parameter, a field, an information element (IE), a configuration, and the like may be interchangeably interpreted. In the present disclosure, a Medium Access Control control element (MAC Control Element (CE)), an update command, an activation/deactivation command, and the like may be interchangeably interpreted.

In the present disclosure, the higher layer signaling may be, for example, any one or combinations of Radio Resource Control (RRC) signaling, Medium Access Control (MAC) signaling, broadcast information, and the like.

In the present disclosure, the MAC signaling may use, for example, a MAC control element (MAC CE), a MAC Protocol Data Unit (PDU), or the like. The broadcast information may be, for example, a master information block (MIB), a system information block (SIB), minimum system information (Remaining Minimum System Information (RMSI)), other system information (OSI), or the like.

In the present disclosure, physical layer signaling may be, for example, downlink control information (DCI), uplink control information (UCI), or the like.

In the present disclosure, an index, an identifier (ID), an indicator, a resource ID, and the like may be interchangeably interpreted. In the present disclosure, a sequence, a list, a set, a group, a cluster, a subset, and the like may be interchangeably interpreted.

In the present disclosure, a panel, a UE panel, a panel group, a beam, a beam group, a precoder, an Uplink (UL) transmission entity, a transmission/reception point (TRP), a base station, spatial relation information (SRI), a spatial relation, an SRS resource indicator (SRI), a control resource set (CORESET), a Physical Downlink Shared Channel (PDSCH), a codeword (CW), a transport block (TB), a reference signal (RS), an antenna port (for example, a demodulation reference signal (DMRS) port), an antenna port group (for example, a DMRS port group), a group (for example, a spatial relation group, a code division multiplexing (CDM) group, a reference signal group, a CORESET group, a Physical Uplink Control Channel (PUCCH) group, a PUCCH resource group), a resource (for example, a reference signal resource, an SRS resource), a resource set (for example, a reference signal resource set), a CORESET pool, a downlink Transmission Configuration Indication state (TCI state) (DL TCI state), an uplink TCI state (UL TCI state), a unified TCI state, a common TCI state, quasi-co-location (QCL), QCL assumption, and the like may be interchangeably interpreted.

A spatial relation information Identifier (ID) (ICI state ID) and spatial relation information (TCI state) may be interchangeably interpreted. “Spatial relation information” may be interchangeably interpreted as “a set of spatial relation information”, “one or a plurality of pieces of spatial relation information”, and the like. The TCI state and the TCI may be interchangeably interpreted.

In the present disclosure, a cell group, a serving cell group, a master cell group (MCG), and a secondary cell group (SCG) may be interchangeably interpreted. L1/L2, L1/L2 signaling, and DCI/MAC CE may be interchangeably interpreted. A serving cell may be replaced with a cell that transmits a PDSCH. A candidate cell may mean a cell for a candidate to be a serving cell by L1/L2 inter-cell mobility.

In the present disclosure, a cell, a PCI, a serving cell, an SpCell, a source serving cell, a CC, a BWP, a BWP in a CC, and a band may be interchangeably interpreted. In the present disclosure, an additional cell, another cell, a non-serving cell, a cell having a different PCI, a candidate cell, a candidate serving cell, a cell having a PCI different from a PCI of a current serving cell, another serving cell, a target cell, and a neighbour cell may be interchangeably interpreted. In the present disclosure, switch, change, and update may be interchangeably interpreted. A serving cell may be interpreted as a serving cell before switch or a serving cell after switch.

In the present disclosure, beam measurement/reporting, L1 beam measurement/reporting, L1 measurement/reporting, and CSI measurement/reporting may be interchangeably interpreted. L1 may indicate at least one of an L1-RSRP and an L1-SINR. An RS may be at least one of a CSI-RS and an SSB. An L1-RSRP and an L1-SINR may be interchangeably interpreted. An SSB, an SSB index, and an SSBRI may be interchangeably interpreted.

### Radio Communication Method

### First Embodiment

When a beam-level/cell-level/multi-beam-level Layer 1 (L1) measurement result meets a condition (for example, any one of conditions of the above-described events A2 to A6 and I1) in order to trigger an aperiodic L1 beam report (CSI report), a specific indication (new indicator) is transmitted from a physical (L1) layer of a UE to a MAC layer. Then, the UE counts the specific indication in the MAC layer, and triggers, based on a counter value of the specific indication (the number of counts), an aperiodic L1 beam report. The UE then transmits the aperiodic L1 beam report (CSI report).

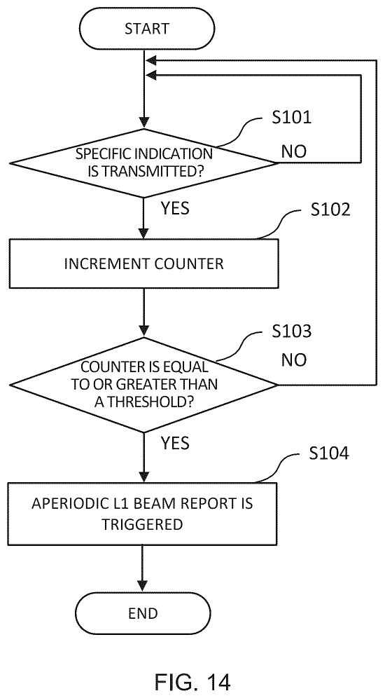

FIG. 14 is a flowchart to show an example of processing according to a first embodiment. A counter (Mobility COUNER) that counts such a specific indication descried above and a timer (mobility timer) are configured. When a specific indication is transmitted from a physical layer (when a condition of any one of events A2 to A6 and I1 is met) (YES in step S101), a MAC layer of a UE increments the counter (step S102). Note that, at the time of step S102, if the timer is not started, the MAC layer of the UE starts or restarts the timer. Then, when the counter is equal to or greater than a threshold (for example, mobilityMaxCount) (YES in step S103), an aperiodic L1 beam report is triggered (step S104).

When the timer expires (when the timer value reaches a certain value or more) or when any one of the timer, the threshold, or a reference signal used for beam measurement/reporting is reconfigured by higher layer signaling or the like, the counter may be configured to “0.” An event and a threshold to be applied may be defined in a specification or may be configured/indicated by higher layer signaling/physical layer signaling.

The UE may transmit (report) UE capability information indicating whether to support the counter, timer, and specific indication. The UE may transmit UE capability information indicating a threshold with respect to the counter.

### Variations

Processing of the present embodiment may be performed only in a physical layer. A UE may count the number of times (or ratio) that a condition of an event is met in a configured period/window and, when the total number of times (or ratio) is larger than a configured threshold, an aperiodic L1 beam report may be triggered.

According to the first embodiment, by using the counter together with the condition described above, transmission of an L1 beam report can be appropriately performed. For example, in order to trigger an aperiodic L1 beam report, it is possible to avoid transmission of an unnecessary L1 beam report.

### Second Embodiment

A UE may judge whether to transmit a cell switching request, based on an L1 beam measurement result. For a method of transmitting such a cell switching request, any one of options below is applied.

### Option 1

With processing according to the first embodiment, when an L1 beam report is triggered (transmitted), an NW (base station) may consider the triggered L1 beam report as a cell switching request. In other words, such an L1 beam report (CSI report) may mean a cell switching request.

### Option 2

When an L1 beam report (CSI report) is triggered based on any one of events A2 to A6 and L1 or on the processing of the first embodiment, a UE may transmit, in the L1 beam report (for example, a report by a MAC CE), an explicit indication indicating a request for cell switching. In other words, the L1 beam report may include a request for cell switching.

When the same L1 beam report includes an L1/L3 beam/cell/multi-beam-level measurement result (including a corresponding beam/cell/multi-beam ID), the beam/cell/multi-beam may be considered as a recommended target cell and a recommended beam of the target cell for cell switching of the UE.

### Variations

A UE may transmit, as a request for cell switching, an implicit indication or individual indication, instead of an explicit indication in an L1 beam report. Based on configuration of RRC signaling, the UE may use an SR resource as a request for cell switching. When an L1 beam report is triggered based on the first embodiment, the UE may transmit, as a cell switching request, an SR related to the L1 beam report and transmit (report) an L1 measurement result by a MAC CE in a PUSCH scheduled by a UL grant.

After transmission of the cell switching request/measurement result, the UE waits for a cell switching command from an NW (base station). The command may be scrambled with a new RNTI or may be transmitted in an individual search space/CORESET. The cell switching command may include at least a target cell ID and a beam ID.

Note that the L1 beam report described above means a measurement result including an L1-RSRP/L1-SINR and the like. The L1 beam report may be transmitted on a MAC CE. In this case, from a view point of reporting signaling, the report may be referred to as an L1 beam report (L2 beam report).

The UE may transmit a UE capability indicating whether to support a cell switching request corresponding to the L1 beam report described above.

According to the second embodiment, when, in L1 beam measurement, it is judged that cell switching is required, a cell switching request can be appropriately transmitted.

### Third Embodiment

### Aspect 1

In Aspect 1, a case of a plurality of cells is described.

### Option 1-1

In each cell, a procedure according to the first/second embodiment may be individually applied.

### Option 1-2

Taking account of conditions of the plurality of cells collectively, a UE may determine, based on the conditions of the plurality of cells, whether to transmit an L1 beam report/cell group switching request.

For example, with respect to step S101 in the first embodiment, when a specific number (X) or more of cells in a cell group meet a condition of any one of events A2 to A6 and I1, a specific indication may be transmitted from a physical layer of a UE to a MAC layer.

With respect to step S103 in the first embodiment, the counters of Y or more of cells in a cell group are each larger than a threshold, an aperiodic L1 beam report may be triggered (step S104).

The UE may receive configurations/indications of the X and Y by higher layer signaling/physical layer signaling. The UE may transmit the X and Y as UE capability information. The X may be the same as or different from the Y.

### Aspect 2

As in the second embodiment, in a case where a UE transmit, to an NW (base station), an indication indicating a request for cell switching, the UE may transmit either single cell switching or cell group switching. For distinguishment between single cell switching and cell group switching, options as below are conceivable.

### Option 2-1

The UE may transmit an explicit indication for distinguishment between single cell switching and cell group switching. For example, in an L1 beam report/cell switching request transmitted by UCI or MAC CE, the UE may transmit one bit of information indicating single cell switching or cell group switching.

### Option 2-2

The UE may transmit an implicit indication for distinguishment between single cell switching and cell group switching. For example, in order to indicate a recommended beam per cell/per cell group, the UE may report only a measurement result for one cell in a case of single cell switching and the UE may report measurement results for a plurality of cells in a case of cell group switching. An NW (base station) can judge single cell switching or cell group switching, based on the transmitted measurement result. The UE may report a target cell group ID in a case of indicating cell group switching.

After transmission of the cell switching request/measurement result, the UE waits for a cell switching command from the NW (base station). The command may be scrambled with a new RNTI may be transmitted in an individual search space/CORESET. The cell switching command includes at least a target cell ID/target cell group ID per cell/cell group and a beam ID.

The cell switching command may include explicit information indicating single cell switching or cell group switching. Alternatively, when having transmitted a request for single cell switching, the UE may expect (assume) that a cell switching command to be received indicates only single cell switching. When having transmitted a request for cell group switching, the UE may expect (assume) that a cell switching command to be received indicates only cell group switching.

### Variations

A response (cell switching command) from an NW corresponding to a cell switching request transmitted from a UE may only include information indicating only “Yes” or “No.” For example, after transmission of a request for either single cell switch or cell group cell switch, the UE may receive a response (cell switching command) indicating “Yes” from the NW.

For example, the response from the NW may be made in accordance with any one of (1) to (3) below. (1), a PDCCH of (2), and a cell switch indication/command of (3) may each indicate “Yes” described above.
(1) In a case of having transmitted a cell switching request in a MAC CE on a PUSCH, a UE receives a PDCCH including DCI that schedules transmission of a PUSCH having an HARQ process number the same as that for transmission of the PUSCH. The DCI includes a toggled NDI field value. Reception of the DCI (PDCCH) allows the UE to judge successful reception of the PUSCH including the cell switching request at an NW, and thus the DCI (PDCCH) may be interpreted as “Yes” indication from the NW.
(2) A UE receives, in a specific search space/CORESET, a PDCCH including specific DCI format X. The specific DCI format X may be a DCI format different from a DCI format that schedules a PDSCH/PUSCH.
(3) A UE receives a cell switch indication/command (or beam indication command) from an NW.

### Fourth Embodiment

For a condition of an event to be a trigger for an L1 beam report, the following condition may be added/applied.

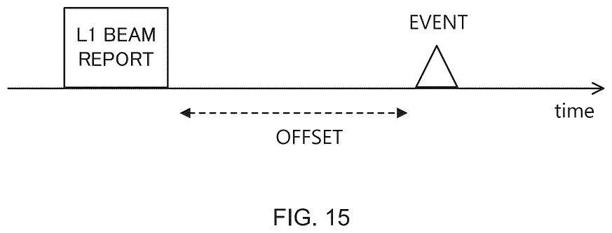

A UE may, in a slot after a certain period (M ms/symbols) from an L1 beam report transmitted last (or in a slot following the slot described above), assume that an event (L beam report) is triggered (trigger an event), and transmit the L1 beam report. The certain period may be defined in a specification or may be configured/indicated by higher layer signaling/physical layer signaling. The UE may transmit UE capability information indicating the certain period. The certain period corresponds to “offset” in FIG. 15.

The certain period may be a period that is applied to a condition for judgement of a TCI state as being known (not unknown) and that is the same as (or shorter than) a period from the last L1 beam report. For example, as one condition to judge a TCI state as being known, it is defined that a TCI state switching command is received within a certain period (1280 ms) after last transmission of a beam report or an RS resource for measurement. In other words, when 1280 ms elapses after the last beam report, a TCI state becomes “unknown.” Thus, the certain period may be 1280 ms (or a period shorter than 1280 ms).

When a TCI state becomes “unknown”, beam switching takes time, but in the processing described above, an L1 beam is reported before a TCI state becomes “unknown”, allowing beam switching to be performed fast. Note that, M may be another value.

### Supplements

### Notification of Information to UE

Notification of any information to a UE ( from a network (NW) (for example, a base station (BS))) (in other words, reception of any information from the BS in the UE) in the above-described embodiments may be performed by using physical layer signaling (for example, DCI), higher layer signaling (for example, RRC signaling, MAC CE), a specific signal/channel (for example, a PDCCH, a PDSCH, a reference signal), or a combination of these.

When the notification is performed by a MAC CE, the MAC CE may be identified by a new logical channel ID (LCID) not defined in an existing standard being included in a MAC subheader.

When the notification is performed by DCI, the notification may be performed by a specific field of the DCI, a radio network temporary identifier (RNTI) used for scrambling of cyclic redundancy check (CRC) bits given to the DCI, a format of the DCI, or the like.

Notification of any information to a UE in the above-described embodiments may be performed periodically, semi-persistently, or aperiodically.

### Notification of Information From UE

Notification of any information from a UE (to an NW) (in other words, transmission/reporting of any information to the BS from the UE) in the above-described embodiments may be performed by using physical layer signaling (for example, UCI), higher layer signaling (for example, RRC signaling, MAC CE), a specific signal/channel (for example, a PUCCH, a PUSCH, a PRACH, a reference signal), or a combination of these.

When the notification is performed by a MAC CE, the MAC CE may be identified by a new LCID not defined in existing standards being included in a MAC subheader.

When the notification is performed by UCI, the notification may be transmitted by using a PUCCH or a PUSCH.

Notification of any information from a UE in the above-described embodiments may be performed periodically, semi-persistently, or aperiodically.

### Regarding Application of Each Embodiment

At least one of the above-described embodiments may be applied to a case satisfying a specific condition. The specific condition may be defined in a standard, or a UE/BS may be notified of the specific condition by using higher layer signaling/physical layer signaling.

At least one of the above-described embodiments may be applied only to a UE that has reported a specific UE capability or that supports the specific UE capability.

The specific UE capability may indicate support of specific processing/operation/control/information related to at least one of the above-described embodiments.

The specific UE capability may be capability applied over all the frequencies (commonly irrespective of frequency), capability per frequency (for example, one or a combination of cell, band, band combination, BWP, component carrier, and the like), capability per frequency range ( for example, Frequency Range 1 (FR1), FR2, FR3, FR4, FR5, FR2-1, FR2-2), capability per subcarrier spacing (SCS), or capability per Feature Set (FS) or Feature Set Per Component-carrier (FSPC).

The specific UE capability may be capability applied over all the duplex schemes (commonly irrespective of duplex scheme) or capability per duplex scheme (for example, time division duplex (TDD) or frequency division duplex (FDD)).

At least one of the above-described embodiments may be applied when the UE is configured/activated/triggered with specific information related to the above-described embodiment (or performance of the operation of the above-described embodiment) by higher layer signaling/physical layer signaling. For example, the specific information may be any RRC parameter for a specific release (for example, Rel. 18/19) or the like.

When the UE does not support at least one of the specific UE capabilities above or is not configured with the specific information, operation of Rel. 15/16 may be applied, for example.

### Supplementary Notes

Regarding one embodiment of the present disclosure, the following supplementary notes of the invention will be given.

### Supplementary Note 1

A terminal including:
a control section that transmits, when a Layer 1 (L1) measurement result meets a condition, a specific indication from a physical layer to a Medium Access Control (MAC) layer, counts the specific indication in the MAC layer, and triggers, based on a counter value, an aperiodic CSI report; and
a transmitting section that transmits the aperiodic CSI report.

### Supplementary Note 2

The terminal according to supplementary note 1, wherein
the CSI report includes a request for cell switching.

### Supplementary Note 3

The terminal according to supplementary note 1 or 2, wherein
the control section transmits, when a specific number or more of cells in a cell group meet the condition, a specific indication from a physical layer to a MAC layer.

### Supplementary Note 4

The terminal according to any one of supplementary notes 1 to 3, wherein
the control section assumes that, in a slot after a certain period from the CSI report transmitted last, an event is triggered.

### Radio Communication System

Hereinafter, a structure of a radio communication system according to one embodiment of the present disclosure will be described. In this radio communication system, the radio communication method according to each embodiment of the present disclosure described above may be used alone or may be used in combination for communication.

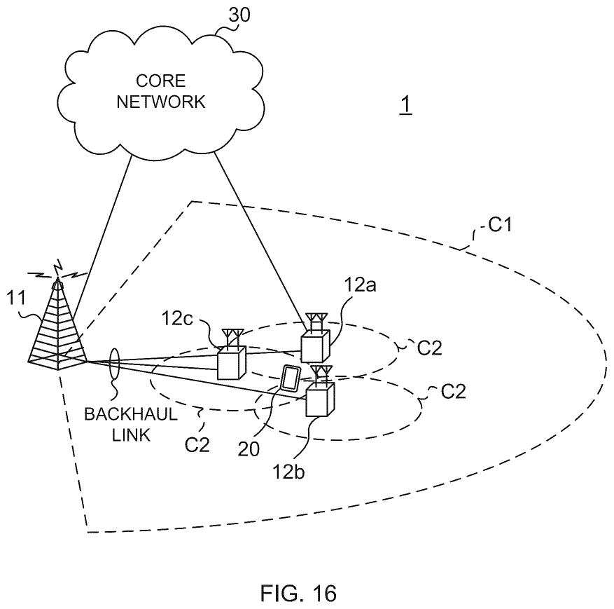

FIG. 16 is a diagram to show an example of a schematic structure of the radio communication system according to one embodiment. The radio communication system 1 (which may be referred to simply as a system 1) may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (qNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHz or less (sub-6 GHz), and FR2 may be a frequency band which is higher than 24 GHz (above-24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (IDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The core network 30 may include network functions (NFs) such as User Plane Function (UPF), Access and Mobility management Function (AMF), Session Management Function (SMF), Unified Data Management (UDM), Application Function (AF), Data Network (DN), Location Management Function (IMF), and maintenance operation management (Operation, Administration and Maintenance (Management) (CAM)), for example. Note that a plurality of functions may be provided by one network node. Communication with an external network (for example, the Internet) may be performed via the DN.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-s-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” on, and DCI for scheduling the PUSCH may be referred to as “UL grant,” “UL DCI,” and so on. Note that the PDSCH may be interpreted as “DL data”, and the PUSCH may be interpreted as “UL data”.

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a certain search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be referred to as a “reference signal.”

In the radio communication system 1, a reference signal for measurement (Sounding Reference Signal (SRS)), a demodulation reference signal (DMRS), or the like may be communicated as an uplink reference signal (UL-RS). Note that DMRS may be referred to as a “user terminal specific reference signal (UE-specific Reference Signal).”

### Base Station

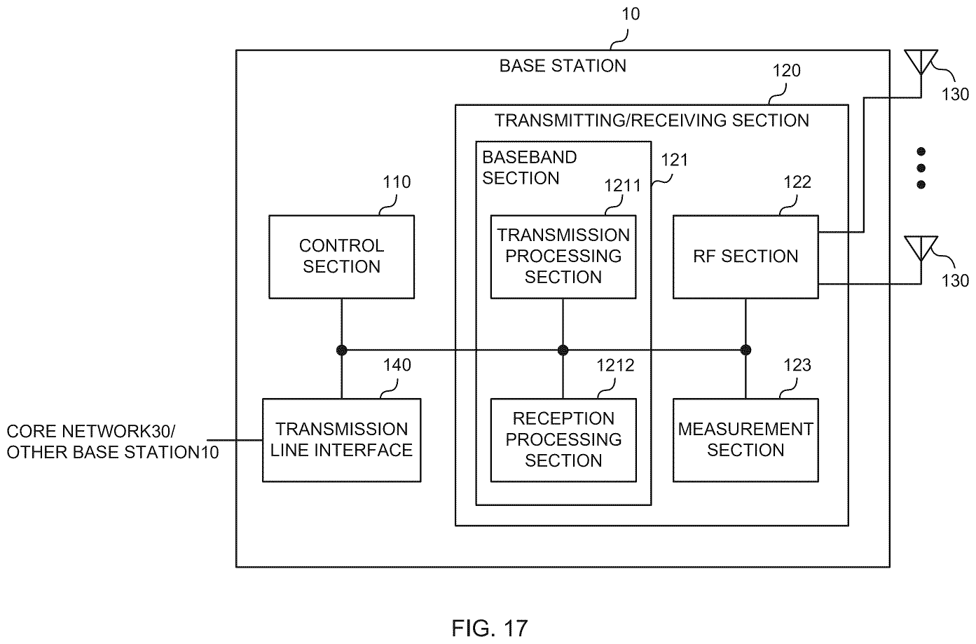

FIG. 17 is a diagram to show an example of a structure of the base station according to one embodiment. The base station 10 includes a control section 110, a transmitting/receiving section 120, transmitting/receiving antennas 130 and a communication path interface (transmission line interface) 140. Note that the base station 10 may include one or more control sections 110, one or more transmitting/receiving sections 120, one or more transmitting/receiving antennas 130, and one or more communication path interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the communication path interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DET) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The communication path interface 140 may perform transmission/reception (backhaul signaling) of a signal with an apparatus (for example, a network node that provides an NF) included in the core network 30 or other base stations 10, and so on, and acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the communication path interface 140.

The control section 110 may assume that, when a Layer 1 (L1) measurement result meets a condition, a specific indication is transmitted from a physical layer of a terminal to a Medium Access Control (MAC) layer, the specific indication is counted in the MAC layer, and, based on a counter value, an aperiodic CSI report is triggered.

Note that the transmitting/receiving section 120 may receive the aperiodic CSI report.

### User Terminal

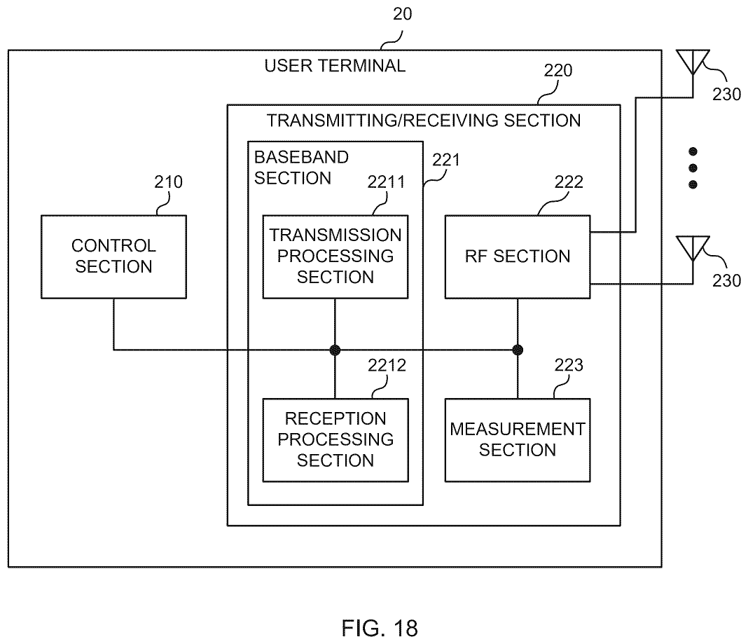

FIG. 18 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DET processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a certain channel (for example, PUSCH), the DFT processing as the above-described transmission processing to transmit the channel by using a DET-s-OFDM waveform if transform precoding is enabled, and otherwise, does not need to perform the DFT processing as the above-described transmission processing.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply reception processing such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal.

For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220 and the transmitting/receiving antennas 230.

The control section 210 may transmit, when a Layer 1 (L1) measurement result meets a condition, a specific indication from a physical layer to a Medium Access Control (MAC) layer, count the specific indication in the MAC layer, and, based on a counter value, trigger an aperiodic CSI report.

The transmitting/receiving section 220 may transmit the aperiodic CSI report.

The CSI report may include a request for cell switching.

The control section 210 may transmit, when a specific number or more of cells in a cell group meet the condition, the specific indication from the physical layer to the MAC layer.

The control section 210 may assume that, in a slot after a certain period from the CSI report transmitted last, a CSI report is triggered.

### Hardware Structure

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate apparatuses (for example, via wire, wireless, or the like) and using these apparatuses. The functional blocks may be implemented by combining software into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but functions are by no means limited to these. For example, a functional block (component) to implement a function of transmission may be referred to as a “transmitting section (transmitting unit)”, a “transmitter”, or the like. The method for implementing each component is not particularly limited as described above.

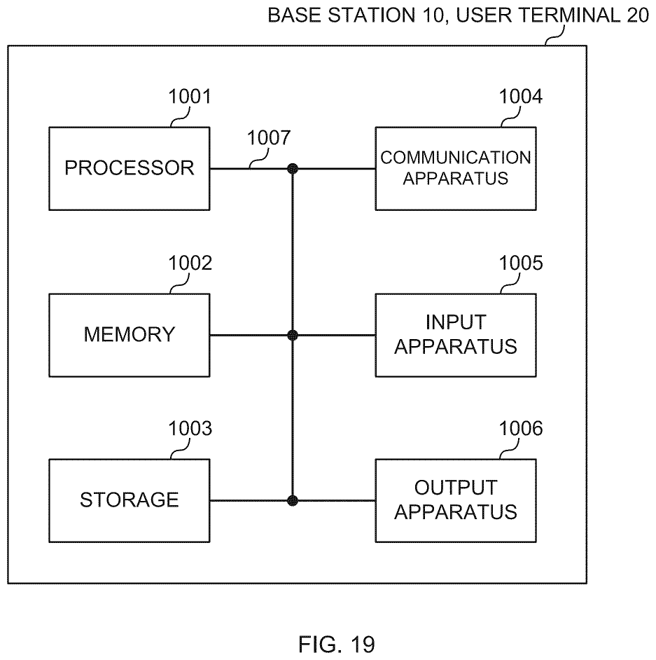

For example, a base station, a user terminal, and so on according to one embodiment of the present disclosure may function as a computer that executes the processes of the radio communication method of the present disclosure. FIG. 19 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably used. The hardware structure of the base station 10 and the user terminal 20 may be configured to include one or more of apparatuses shown in the drawings, or may be configured not to include part of apparatuses.

For example, although one processor 1001 is shown in the drawings, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminal 20 is implemented, for example, by allowing certain software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least a part of the control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least a part of the operations explained in the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register”, a “cache”, a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “auxiliary storage apparatus”.

The communication apparatus 1004 is hardware (transmitting/receiving device) for allowing inter-computer communication via at least one of wired and wireless networks, and may be referred to as, for example, a “network device”, a “network controller”, a “network card”, a “communication module”, and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the transmitting/receiving section 120 (220), the transmitting/receiving antenna 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor or the like). The output apparatus 1006 is an output device that allows sending output to the outside (for example, a display, a speaker, a Light Emitting Diode (LED) lamp or the like). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between apparatuses.

Also, the base station 10 and the user terminal 20 may be structured to include hardware such as a microprocessor, a Digital Signal Processor (DSP), an Application Specific Integrated Circuit (ASIC), a Programmable Logic Device (PLD), a Field Programmable Gate Array (FPGA), and so on, and a part or all of the functional blocks may be implemented by the hardware. For example, the processor 1001 may be implemented with at least one of these pieces of hardware.

### Variations

It should be noted that a term used in the present disclosure and a term required for understanding of the present disclosure may be replaced by a term having the same or similar meaning. For example, a channel, a symbol, and a signal (or signaling) may be interchangeably used. Further, a signal may be a message. A reference signal may be abbreviated as an RS, and may be referred to as a pilot, a pilot signal or the like, depending on which standard applies. Furthermore, a component carrier (CC) may be referred to as a cell, a frequency carrier, a carrier frequency and so on.

A radio frame may be constituted of one or a plurality of periods (frames) in the time domain. Each of one or a plurality of periods (frames) constituting a radio frame may be referred to as a “subframe”. Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a specific filter processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. each mini-slot may be constituted of one or a plurality of symbols in the time domain. A mini-slot may be referred to as a “sub-slot”. A mini-slot may be constituted of symbols in number less than the slot. A PDSCH (or PUSCH) transmitted in a time unit larger than a mini-slot may be referred to as “PDSCH (PUSCH) mapping type A”. A PDSCH (or PUSCH) transmitted using a mini-slot may be referred to as “PDSCH (PUSCH) mapping type B”.

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably used.

For example, one subframe may be referred to as a “TTI”, a plurality of consecutive subframes may be referred to as a “TTI”, or one slot or one mini-slot may be referred to as a “TTI”. In other words, at least one of a subframe and a TTI may be a subframe (1 ms) in existing LTE, may be a period shorter than 1 ms (for example, 1 to 13 symbols), or may be a period longer than 1 ms. Note that a unit expressing TTI may be referred to as a “slot”, a “mini-slot”, or the like, instead of a “subframe”.

Here, a TTI refers to the minimum time unit of scheduling in radio communication, for example. For example, in LTE systems, a base station performs, for user terminals, scheduling of allocating of radio resources (such as a frequency bandwidth and transmit power that are available for each user terminal) in TTI units. Note that the definition of TTIs is not limited to this.

The TTI may be a transmission time unit for channel-encoded data packets (transport blocks), code blocks, codewords, or the like, or may be a unit of processing in scheduling, link adaptation, or the like. Note that, when a TTI is given, a time interval (for example, the number of symbols) to which transport blocks, code blocks, codewords, or the like are actually mapped may be shorter than the TTI.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI”, a “normal subframe”, a “long subframe”, a “slot” and so on. A TTI that is shorter than a normal TTI may be referred to as a “shortened TTI”, a “short TTI”, a “partial or fractional TTI”, a “shortened subframe”, a “short subframe”, a “mini-slot”, a “sub-slot”, a “slot”and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB))”, a “sub-carrier group (SCG)”, a “resource element group (REG)”, a “PRB pair”, an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth”, and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for UL) and a DL BWP (BWP for DL). One or a plurality of BWPs may be configured in one carrier for a UE.

At least one of configured BWPs may be active, and a UE may not need to assume to transmit/receive a certain signal/channel outside the active BWP(s). Note that a “cell”, a “carrier”, and so on in the present disclosure may be used interchangeably with a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Further, the information, parameters, and so on described in the present disclosure may be expressed using absolute values or relative values with respect to certain values, or may be expressed using another corresponding information. For example, a radio resource may be specified by a certain index.

The names used for parameters and so on in the present disclosure are in no respect used as limitations. Furthermore, mathematical expressions that use these parameters, and so on may be different from those explicitly disclosed in the present disclosure. Since various channels (PUCCH, PDCCH, and so on) and information elements may be identified by any suitable names, the various names allocated to these various channels and information elements are in no respect used as limitations.

The information, signals, and so on described in the present disclosure may be represented by using any of a variety of different technologies. For example, data, an instruction, a command, information, a signal, a bit, a symbol, a chip, and so on, described throughout the description of the present application, may be represented by a voltage, an electric current, electromagnetic waves, magnetic fields, a magnetic particle, optical fields, a photon, or any combination thereof.

Also, information, signals, and so on can be output at least one of from a higher layer to a lower layer and from a lower layer to a higher layer. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or added. The information, signals, and so on that has been output may be deleted. The information, signals, and so on that has been input may be transmitted to another apparatus.

Notification of information is by no means limited to the aspects/embodiments described in the present disclosure, and other methods may be used as well. For example, notification of information in the present disclosure may be implemented by using physical layer signaling (for example, downlink control information (DCI), uplink control information (UCI)), higher layer signaling (for example, Radio Resource Control (RRC) signaling, broadcast information (master information block (MIB), system information block (SIB), and so on), Medium Access Control (MAC) signaling and so on), and other signals or combinations of these.

Note that physical layer signaling may be referred to as “Layer 1/Layer 2 (L1/L2) control information (L1/L2 control signals)”, “L1 control information (L1 control signal)”, and so on. Also, RRC signaling may be referred to as an “RRC message”, and can be, for example, an RRC connection setup message, an RRC connection reconfiguration message, and so on. Also, MAC signaling may be notified using, for example, MAC control elements (MAC CES).

Also, notification of certain information (for example, notification of “X”) does not necessarily have to be performed explicitly, and can be performed implicitly (by, for example, not reporting this certain information or reporting another piece of information).

A decision may be realized by a value (0 or 1) represented by one bit, by a boolean value (true or false), or by comparison of numerical values (e.g., comparison with a certain value).

Software, irrespective of whether referred to as “software”, “firmware”, “middleware”, “microcode”, or “hardware description language”, or called by other terms, should be interpreted broadly to mean instructions, instruction sets, codes, code segments, program codes, programs, subprograms, software modules, applications, software applications, software packages, routines, subroutines, objects, executable files, execution threads, procedures, functions, and the like.

Also, software, instructions, information, and the like may be transmitted and received via a transmission medium. For example, when software is transmitted from a website, a server, or other remote sources by using at least one of wired technologies (coaxial cable, fiber optic cable, twisted-pair cable, digital subscriber line (DSL), and so on) and wireless technologies (infrared radiation, microwaves, and so on), at least one of these wired technologies and wireless technologies is also included in the definition of the transmission medium.

The terms “system” and “network” used in the present disclosure may be used interchangeably. The “network” may mean an apparatus (for example, a base station) included in the network.

In the present disclosure, the terms such as “precoding”, a “precoder”, a “weight (precoding weight)”, “quasi-co-location (QCL)”, a “Transmission Configuration Indication state (TCI state)”, a “spatial relation”, a “spatial domain filter”, a “transmit power”, “phase rotation”, an “antenna port”, an “antenna port group”, a “layer”, “the number of layers”, a “rank”, a “resource”, a “resource set”, a “resource group”, a “beam”, a “beam width”, a “beam angular degree”, an “antenna”, an “antenna element”, a “panel”, and so on may be used interchangeably.

In the present disclosure, the terms such as a “base station (BS)”, a “radio base station”, a “fixed station,” a “NodeB”, an “eNB (eNodeB)”, a “gNB (gNodeB)”, an “access point”, a “transmission point (TP)”, a “reception point (RP)”, a “transmission/reception point (TRP)”, a “panel”, a “cell”, a “sector”, a “cell group”, a “carrier”, a “component carrier”, and so on can be used interchangeably. The base station may be referred to as the terms such as a “macro cell”, a “small cell”, a “femto cell”, a “pico cell”, and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, transmitting information to the terminal by the base station may be interchangeably interpreted as instructing the terminal to perform control/operation based on the information by the base station.

In the present disclosure, the terms “mobile station (MS)”, “user terminal”, “user equipment (UE)”, and “terminal” may be used interchangeably.

A mobile station may be referred to as a “subscriber station”, “mobile unit”, “subscriber unit”, “wireless unit”, “remote unit”, “mobile device”, “wireless device”, “wireless communication device”, “remote device”, “mobile subscriber station”, “access terminal”, “mobile terminal”, “wireless terminal”, “remote terminal”, “handset”, “user agent”, “mobile client”, “client”, or some other appropriate terms in some cases.

At least one of a base station and a mobile station may be referred to as a “transmitting apparatus”, a “receiving apparatus”, a “radio communication apparatus” or the like. Note that at least one of a base station and a mobile station may be a device mounted on a moving object or a moving object itself, and so on.

The moving object is a movable object with any moving speed, and naturally, it also includes a moving object stopped. Examples of the moving object include a vehicle, a transport vehicle, an automobile, a motorcycle, a bicycle, a connected car, a loading shovel, a bulldozer, a wheel loader, a dump truck, a fork lift, a train, a bus, a trolley, a rickshaw, a ship and other watercraft, an airplane, a rocket, a satellite, a drone, a multicopter, a quadcopter, a balloon, and an object mounted on any of these, but these are not restrictive. The moving object may be a moving object that autonomously travels based on a direction for moving.

The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor.

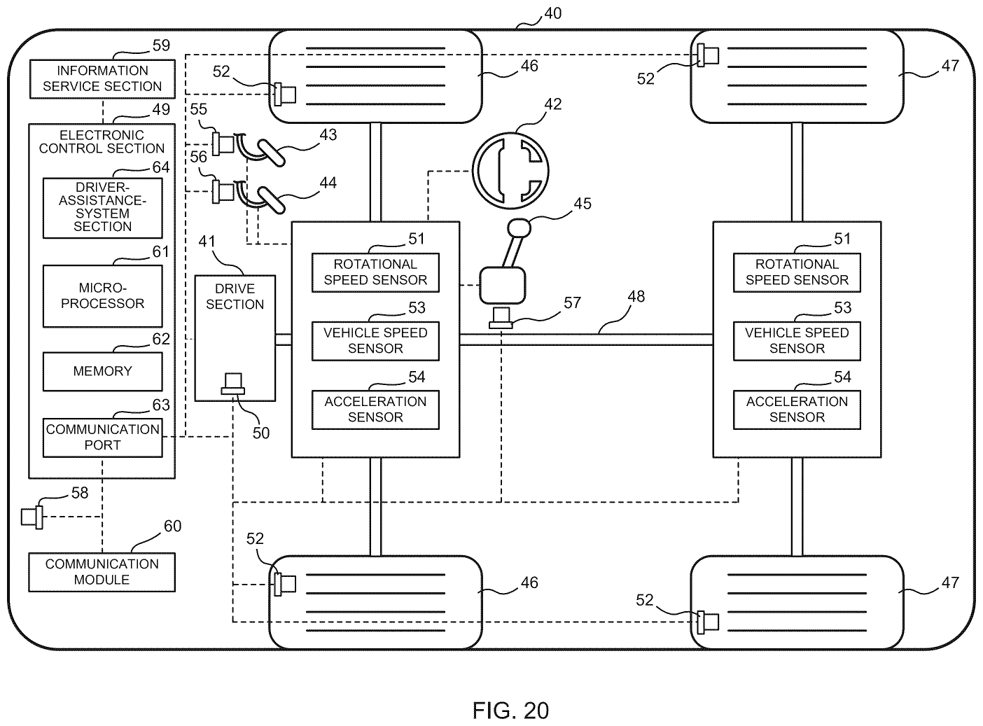

FIG. 20 is a diagram to show an example of a vehicle according to one embodiment. A vehicle 40 includes a driving section 41, a steering section 42, an accelerator pedal 43, a brake pedal 44, a shift lever 45, right and left front wheels 46, right and left rear wheels 47, an axle 48, an electronic control section 49, various sensors (including a current sensor 50, a rotational speed sensor 51, a pneumatic sensor 52, a vehicle speed sensor 53, an acceleration sensor 54, an accelerator pedal sensor 55, a brake pedal sensor 56, a shift lever sensor 57, and an object detection sensor 58), an information service section 59, and a communication module 60.

The driving section 41 includes, for example, at least one of an engine, a motor, and a hybrid of an engine and a motor. The steering section 42 includes at least a steering wheel (also referred to as a handle), and is configured to steer at least one of the front wheels 46 and the rear wheels 47, based on operation of the steering wheel operated by a user.

The electronic control section 49 includes a microprocessor 61, a memory (ROM, RAM) 62, and a communication port (for example, an input/output (IO) port) 63. The electronic control section 49 receives, as input, signals from the various sensors 50 to 58 provided in the vehicle. The electronic control section 49 may be referred to as an Electronic Control Unit (ECU).

Examples of the signals from the various sensors 50 to 58 include a current signal from the current sensor 50 for sensing current of a motor, a rotational speed signal of the front wheels 46/rear wheels 47 acquired by the rotational speed sensor 51, a pneumatic signal of the front wheels 46/rear wheels 47 acquired by the pneumatic sensor 52, a vehicle speed signal acquired by the vehicle speed sensor 53, an acceleration signal acquired by the acceleration sensor 54, a depressing amount signal of the accelerator pedal 43 acquired by the accelerator pedal sensor 55, a depressing amount signal of the brake pedal 44 acquired by the brake pedal sensor 56, an operation signal of the shift lever 45 acquired by the shift lever sensor 57, and a detection signal for detecting an obstruction, a vehicle, a pedestrian, and the like acquired by the object detection sensor 58.

The information service section 59 includes: various devices for providing (outputting) various pieces of information such as driving information, traffic information, and entertainment information, such as a car navigation system, an audio system, a speaker, a display, a television, and a radio; and one or more ECUs that control these devices. The information service section 59 provides various pieces of information/services (for example, multimedia information/multimedia service) to an occupant of the vehicle 40, using information acquired from an external apparatus via the communication module 60 and the like.

The information service section 59 may include an input device (for example, a keyboard, a mouse, a microphone, a switch, a button, a sensor, a touch panel, and the like) for receiving input from the outside, or may include an output device (for example, a display, a speaker, an LED lamp, a touch panel, and the like) for implementing output to the outside.

A driving assistance system section 64 includes: various devices for providing functions for preventing an accident and reducing a driver's driving load, such as a millimeter wave radar, Light Detection and Ranging (LIDAR), a camera, a positioning locator (for example, a Global Navigation Satellite System (GNSS) and the like), map information (for example, a high definition (HD) map, an autonomous vehicle (AV) map, and the like), a gyro system (for example, an inertial measurement apparatus (inertial measurement unit (IMU)), an inertial navigation apparatus (inertial navigation system (INS)), and the like), an artificial intelligence (AI) chip, and an AI processor; and one or more ECUs that control these devices. The driving assistance system section 64 transmits and receives various pieces of information via the communication module 60, and implements a driving assistance function or an autonomous driving function.

The communication module 60 can communicate with the microprocessor 61 and the constituent elements of the vehicle 40 via the communication port 63. For example, the communication module 60 transmits and receives data (information), via the communication port 63, to and from the driving section 41, the steering section 42, the accelerator pedal 43, the brake pedal 44, the shift lever 45, the right and left front wheels 46, the right and left rear wheels 47, the axle 48, the microprocessor 61 and the memory (ROM, RAM) 62 in the electronic control section 49, and the various sensors 50 to 58, which are included in the vehicle 40.

The communication module 60 is a communication device that can be controlled by the microprocessor 61 of the electronic control section 49 and that can perform communication with an external apparatus. For example, the communication module 60 performs transmission and reception of various pieces of information to and from the external apparatus via radio communication. The communication module 60 may be either inside or outside the electronic control section 49. The external apparatus may be, for example, the base station 10, the user terminal 20, or the like described above. The communication module 60 may be, for example, at least one of the base station 10 and the user terminal 20 described above (may function as at least one of the base station 10 and the user terminal 20).

The communication module 60 may transmit at least one of signals input from the various sensors 50 to 58 to the electronic control section 49, information obtained based on the signals, and information based on an input from the outside (a user) obtained via the information service section 59, to the external apparatus via radio communication. The electronic control section 49, the various sensors 50 to 58, the information service section 59, and the like may be referred to as input sections that receive input. For example, the PUSCH transmitted by the communication module 60 may include information based on the input.

The communication module 60 receives various pieces of information (traffic information, signal information, inter-vehicle distance information, and the like) transmitted from the external apparatus, and displays the received information on the information service section 59 included in the vehicle. The information service section 59 may be referred to as an output section that outputs information (for example, outputs information to devices, such as a display and a speaker, based on the PDSCH received by the communication module 60 (or data/information decoded from the PDSCH)).

The communication module 60 stores the various pieces of information received from the external apparatus in the memory 62 that can be used by the microprocessor 61. Based on the pieces of information stored in the memory 62, the microprocessor 61 may control the driving section 41, the steering section 42, the accelerator pedal 43, the brake pedal 44, the shift lever 45, the right and left front wheels 46, the right and left rear wheels 47, the axle 48, the various sensors 50 to 58, and the like provided in the vehicle 40.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D)”, “Vehicle-to-Everything (V2X)”, and the like). In this case, user terminals 20 may have the functions of the base stations 10 described above. The words such as “uplink” and “downlink” may be interpreted as the words corresponding to the terminal-to-terminal communication (for example, “sidelink”). For example, an uplink channel, a downlink channel and so on may be interpreted as a sidelink channel.

Likewise, the user terminal in the present disclosure may be interpreted as a base station. In this case, the base station 10 may have the functions of the user terminal 20 described above.

Operations which have been described in the present disclosure to be performed by a base station may, in some cases, be performed by an upper node of the base station. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

Each aspect/embodiment described in the present disclosure may be used independently, may be used in combination, or may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (ITE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced, modified, created, or defined based on these. A plurality of systems may be combined (for example, a combination of LTE or LTE-A and 5G, and the like) for application.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first”, “second”, and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “deciding (determining)” as in the present disclosure herein may encompass a wide variety of actions. For example, “deciding (determining)” may be interpreted to mean making “decisions (determinations)” about judging, calculating, computing, processing, deriving, investigating, looking up, search and inquiry (for example, searching a table, a database, or some other data structures), ascertaining, and so on.

Furthermore, “deciding (determining)” may be interpreted to mean making “decisions (determinations)” about receiving (for example, receiving information), transmitting (for example, transmitting information), input, output, accessing (for example, accessing data in a memory), and so on.

In addition, “deciding (determining)” as used herein may be interpreted to mean making “decisions (determinations)” about resolving, selecting, choosing, establishing, comparing, and so on. In other words, “deciding (determining)” may be interpreted to mean making “decisions (determinations)”about some action.

“Decide/deciding (determine/determining)” may be used interchangeably with “assume/assuming”, “expect/expecting”, “consider/considering”, and the like.

“The maximum transmit power” described in the present disclosure may mean a maximum value of the transmit power, may mean the nominal maximum transmit power (the nominal UE maximum transmit power), or may mean the rated maximum transmit power (the rated UE maximum transmit power).

The terms “connected”, “coupled”, or any variation of these terms as used in the present disclosure mean any direct or indirect connections or coupling between two or more elements, and may include the presence of one or more intermediate elements between two elements that are “connected” or “coupled” to each other. The coupling or connection between the elements may be physical, logical, or a combination thereof. For example, “connection”may be interpreted as “access”.

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other”. It should be noted that the phrase may mean that “A and B are each different from C”. The terms “separate”, “coupled”, and so on may be interpreted similarly to “different”.

In the case where the terms “include”, “including”, and variations thereof are used in the present disclosure, these terms are intended to be comprehensive, in a manner similar to the term “comprising”. Furthermore, the term “or” used in the present disclosure is not intended to be an “exclusive or”.

For example, in the present disclosure, where an article such as “a”, “an”, and “the” is added by translation, the present disclosure may include that a noun after the article is in a plural form.

In the present disclosure, “equal to or less than”, “less than”, “equal to or more than”, “more than”, “equal to”, and the like may be used interchangeably. In the present disclosure, words such as “good”, “bad”, “large”, “small”, “high”, “low”, “early”, “late”, “wide”, “narrow”, and the like may be used interchangeably irrespective of positive degree, comparative degree, and superlative degree. In the present disclosure, expressions obtained by adding “i-th” (i is any integer) to words such as “good”, “bad”, “large”, “small”, “high”, “low”, “early”, “late”, “wide”, “narrow”, and the like may be used interchangeably irrespective of positive degree, comparative degree, and superlative degree (for example, “best” may be used interchangeably with “i-th best”, and vice versa).

In the present disclosure, “of”, “for”, “regarding”, “related to”, “associated with”, and the like may be used interchangeably.

Now, although the invention according to the present disclosure has been described in detail above, it is apparent to a person skilled in the art that the invention according to the present disclosure is by no means limited to the embodiments described in the present disclosure. Modifications, alternatives, replacements, etc., of the invention according to the present disclosure may be possible without departing from the subject matter and the scope of the present invention defined based on the descriptions of claims. The description of the present disclosure is provided only for the purpose of explaining examples, and should by no means be construed to limit the invention according to the present disclosure in any way.

What is claimed is:

1. A terminal comprising:
a control section that transmits, when a Layer 1 (L1) measurement result meets a condition, a specific indication from a physical layer to a Medium Access Control (MAC) layer, counts the specific indication in the MAC layer, and triggers, based on a counter value, an aperiodic CSI report; and
a transmitting section that transmits the aperiodic CSI report.

2. The terminal according to claim 1, wherein
the CSI report includes a request for cell switching.

3. The terminal according to claim 1, wherein
the control section transmits, when a specific number or more of cells in a cell group meet the condition, the specific indication from the physical layer to the MAC layer.

4. The terminal according to claim 1, wherein
the control section assumes that, in a slot after a certain period from the CSI report transmitted last, the CSI report is triggered.

5. A radio communication method for a terminal, the radio communication method comprising:
transmitting, when a Layer 1 (L1) measurement result meets a condition, a specific indication from a physical layer to a Medium Access Control (MAC) layer, counting the specific indication in the MAC layer, and triggering, based on a counter value, an aperiodic CSI report; and
transmitting the aperiodic CSI report.

6. A base station comprising:
a control section that assumes that, when a Layer 1 (L1) measurement result meets a condition, a specific indication is transmitted from a physical layer of a terminal to a Medium Access Control (MAC) layer, the specific indication is counted in the MAC layer, and, based on a counter value, an aperiodic CSI report is triggered; and
a receiving section that receives the aperiodic CSI report.
